(19) United States
(12) Patent Application Publication
(10) Pub. No.: US 2009/0021960 A1
(43) Pub. Date: Jan. 22, 2009

(54) Luminescent decorating panel assembly and electronic device using the same

(76) Inventors: Shih-Kun Yeh, Luchu Hsiang (TW); Chun-Tai Lee, Luchu Hsiang (TW)

Correspondence Address: TROXELL LAW OFFICE PLLC, SUITE 1404, 5205 LEESBURG PIKE, FALLS CHURCH, VA, 22041, US

(21) Appl. No.: 12/003,659

(22) Filed: Dec. 28, 2007

(30) Foreign Application Priority Data
Jul. 20, 2007 (TW) 096211872

(51) Int. Cl. F21V 5/00

(52) U.S. Cl. 362/612

(57) ABSTRACT

A luminescent decorating panel assembly and an electronic device using the luminescent decorating panel are disclosed. The luminescent decorating panel assembly includes a light guide plate, a light source and a reflecting element, and a microstructure is formed on a light exit plane of the light guide plate and applied in the electronic device, and the luminescent decorating panel assembly is disposed between an upper casing and a lower casing of the electronic device, and the microstructure corresponds to a transparent portion of the upper casing, such that when a user views the microstructure on the light guide plate through the transparent portion, a luminescent effect is produced on the electronic device.

### BACKGROUND OF THE INVENTION

1. Field of the Invention

The present invention relates to a design of a luminescent decorating panel assembly, and more particularly to a luminescent decorating panel assembly applied to an electronic device.

2. Description of the Related Art

As high technologies advance, many consumer products are designed with standard specifications, but many personalized product designs are still found in such invariable products. For example, manufacturers continuously introduce new designs and models of mobile phones, allow users to change the casing of their mobile phones, and provide designs of color logos. All these are breakthroughs of the invariable mobile phone products and capable of improving the add-on value of the products.

Manufacturers also intend to provide special features for consumer products, and the present invention intends to follow this trend, such as printing a designed logo on a casing of the product. In a bright environment, people can see the logo clearly, but in a dark environment, people may have difficulty to see the logo at all since the logo is not a luminescent one.

### SUMMARY OF THE INVENTION

It is a primary objective of the present invention to provide a luminescent decorating panel assembly that emits lights; so that when the luminescent decorating panel assembly is applied in an electronic device, the characteristics and technical advantages of the present invention can be used for clearly showing the design of a logo.

To make it easier for our examiner to understand the characteristics and advantages of the present invention, we use preferred embodiments of a connector having a protecting element accompanied with related drawings for a detailed description of the present invention.

In a preferred embodiment of the present invention, a luminescent decorating panel assembly comprises a light guide plate, a light source and a reflecting element, wherein the light guide plate includes an incident plane and a light exit plane, and the top or bottom of the light exit plane forms a microstructure, such that if the light produced by the light source is passed through an incident plane into the light guide plate, the light will exit from the light exit plane.

The present invention can be applied to an electronic device, wherein the electronic device comprises a lower casing and an upper casing, and the upper casing includes a transparent portion thereon, and the luminescent decorating panel assembly is installed between the upper casing and the lower casing, and a microstructure corresponds to the transparent portion, such that when a user views the microstructure on a light guide plate through the transparent portion, the electronic device produces a luminescent effect to attract the user's attention. In addition, the microstructure can be designed with a visual effect such as the design of a pattern or a logo to improve the add-on value of the product.

### BRIEF DESCRIPTION OF THE DRAWINGS

FIG. 1 is an exploded view of a luminescent decorating panel assembly in accordance with a first preferred embodiment of the present invention;

FIG. 2 is a section view of a portion of FIG. 1;

FIG. 3 is a section view of a luminescent decorating panel assembly in accordance with a second preferred embodiment of the present invention and a portion of an electronic device;

FIG. 4 is a section view of a luminescent decorating panel assembly in accordance with a third preferred embodiment of the present invention and a portion of an electronic device;

FIG. 5 is a perspective view of a luminescent decorating panel assembly applied in a notebook computer in accordance with the present invention;

FIG. 6 is a perspective view of a luminescent decorating panel assembly applied in a personal digital assistant (PDA) in accordance with the present invention;

FIG. 7 is a perspective view of a luminescent decorating panel assembly applied in a digital camera in accordance with the present invention; and

FIG. 8 is a perspective view of a luminescent decorating panel assembly applied in a speaker in accordance with the present invention.

### DETAILED DESCRIPTION OF THE PREFERRED EMBODIMENTS

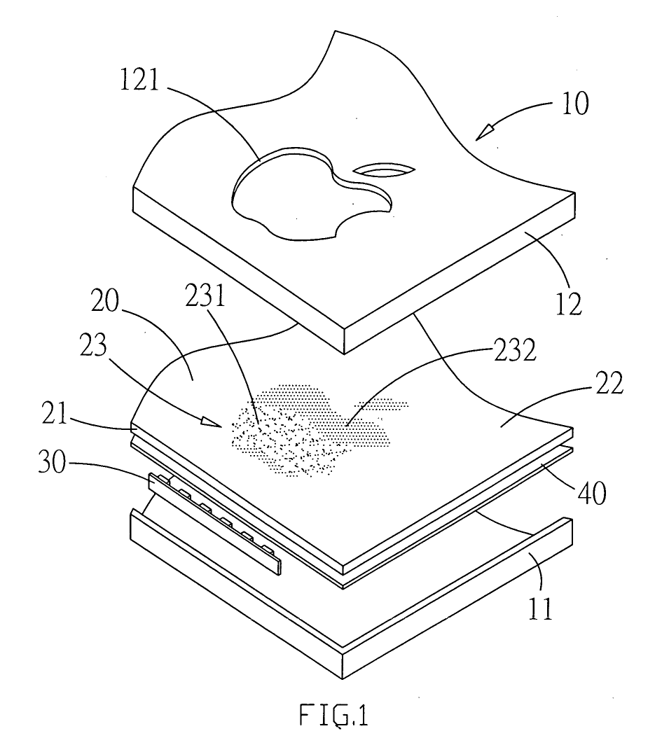

Referring to FIG. 1 for an exploded view of a luminescent decorating panel assembly in accordance with a first preferred embodiment of the present invention and an electronic device, the electronic device 10 includes a lower casing 11 and an upper casing 12, and the upper casing 12 and the lower casing 11 are engaged with each other to form an integral body, and the upper casing 12 has a transparent portion 121 (which can be hollow or transparent). The luminescent decorating panel assembly of this preferred embodiment includes a light guide plate 20, a light source 30 and a reflecting element 40, and the light guide plate 20 has an incident plane 21 and a light exit plane 22, and the top of the light exit plane 22 forms a microstructure 23 corresponding to the transparent portion 121. The microstructure 23 further includes a first pattern area 231 and a second pattern area 232, and the first pattern area 231 and the second pattern area 232 include a plurality of microstructures with different distributions, densities, shapes and sizes to produce different light refraction rates or different layers.

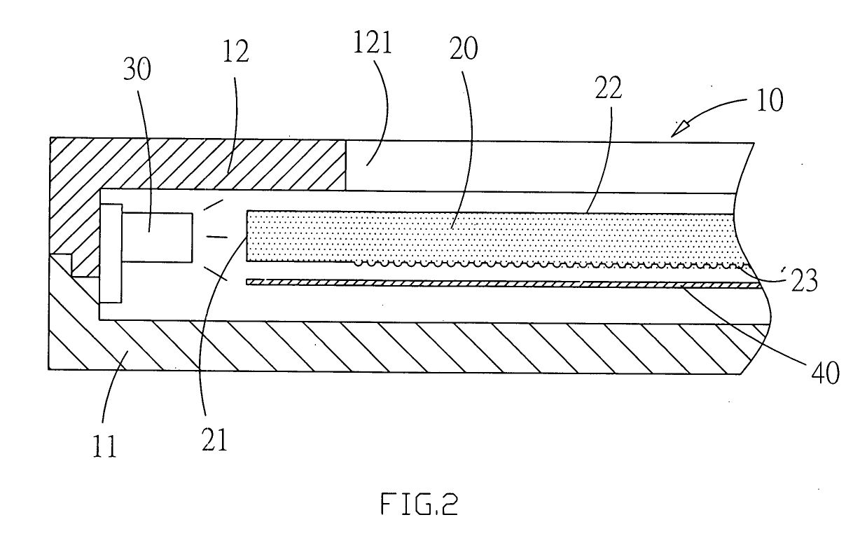

Referring to FIG. 2, the incident plane 21 is disposed on a side of the light guide plate 20, and the light source 30 is disposed on internal sides of the upper casing 12 and the lower casing 11 on a side of the light guide plate 20 and corresponding to the incident plane 21, and the light source 30 can be a light emitting diode or a fluorescent lamp (preferably a cold cathode fluorescent lamp), and the reflecting element 40 is installed between the light guide plate 20 and the lower casing 11, and the reflecting element 40 adopted by this embodiment is a reflecting plate, and the microstructure 23 of this embodiment is formed at the bottom of the light guide plate 20 (which is also the bottom of the light exit plane 22).

After a light emitted from the light source 30 is passed through the incident plane 21 into the light guide plate 20 and reflected from the light exit plane 22 and a portion of the light source is refracted (or reflected) by the reflecting element 40, the light may still exit from the light exit plane 22, so that when a user views the microstructure 23 on the light guide plate 20 through the transparent portion 121, a luminescent effect is produced to attract the user's attention. Since the microstructure 23 includes a first pattern area 231 and a second pattern area 232 of the microstructures having different light refractive rates or different layers, viewers can see different brightness's while viewing from the outside, and different visual effects will be produced in a single area of the transparent portion 121. With such arrangement, more rooms of creations are provided for the visual design of the microstructures 23 such as the design of a pattern or a trademark, etc.

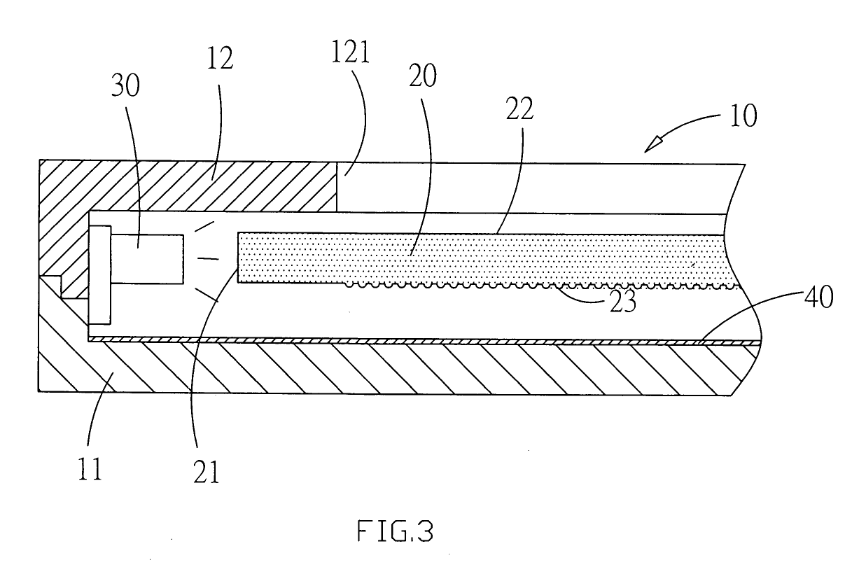

Referring to FIG. 3 for a section view of a luminescent decorating panel assembly in accordance with a second preferred embodiment of the present invention (wherein a reflecting element is disposed on a casing) and a portion of an electronic device, the reflecting element 40 is installed at the bottom of the lower casing 11 to conform with the design and specification of the product. In other words, the reflecting element 40 and the lower casing 11 are combined to form an integral component, so as to facilitate the assembling process and lower the production cost. The light sources 30 of both first and second preferred embodiments are disposed on the same side of the light guide plate 20, and thus the light source 30 is defined as a side incident light.

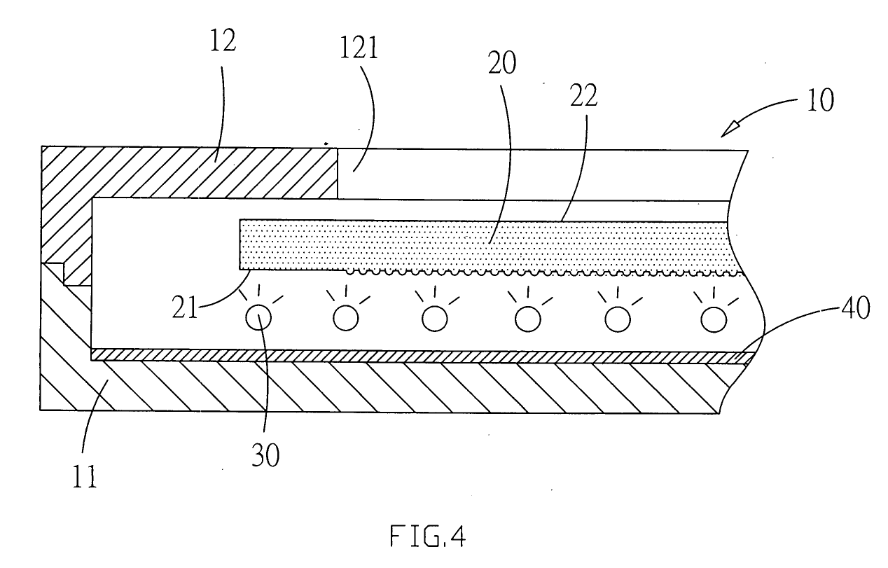

Referring to FIG. 4 for a luminescent decorating panel assembly in accordance with a third preferred embodiment of the invention (backside incident light) and a portion of an electronic device, the backside incident light is another way of installing the light source 30. With the design of the reflecting element 40 installed at the bottom of the lower casing 11 as illustrated in the second preferred embodiment, the light source 30 is installed between the bottom of the light guide plate 20 and the reflecting element 40. The incident plane 21 is disposed at the bottom of the light guide plate 20, and the light produced by the light source 30 is incident from the incident plane 21 at the bottom of the light guide plate 20, and exited from the light exit plane 22 at the top of the light guide plate 20, and a vast majority of the light is entered and exited directly, and a small portion of the light also enters into the light guide plate 20 through the reflecting element 40, and such light source is called a direct type incident light.

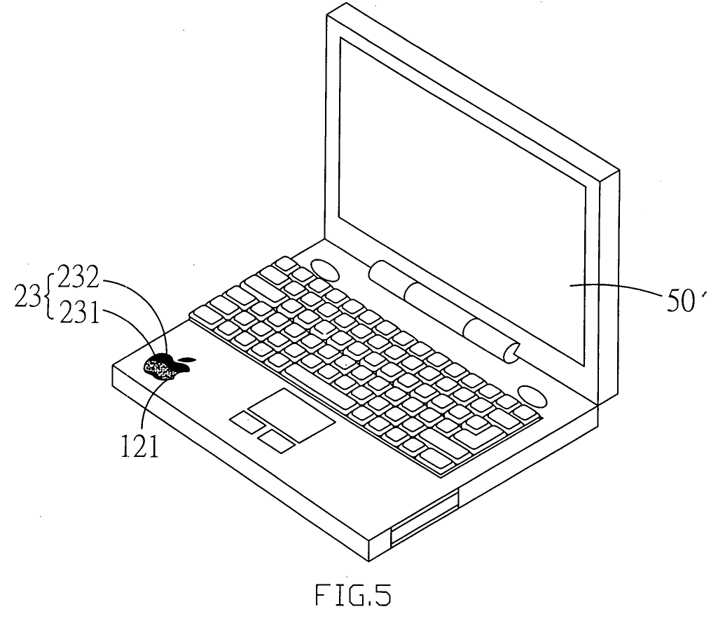

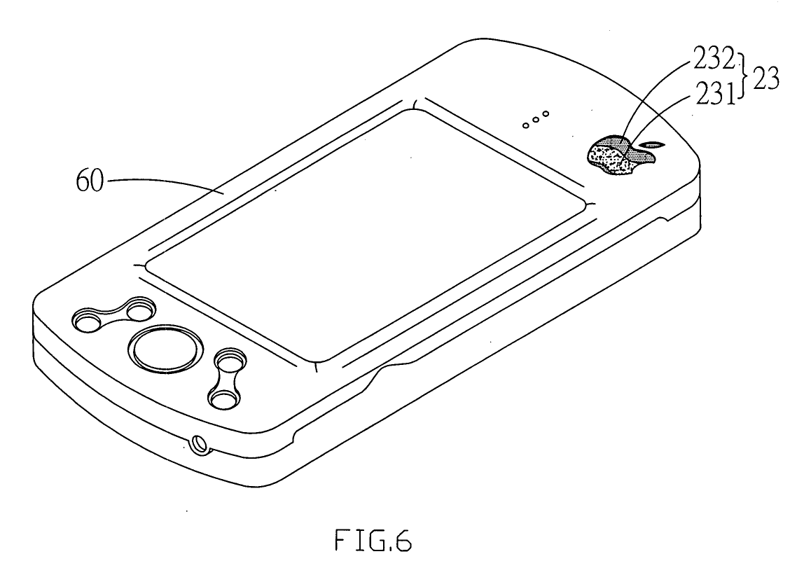

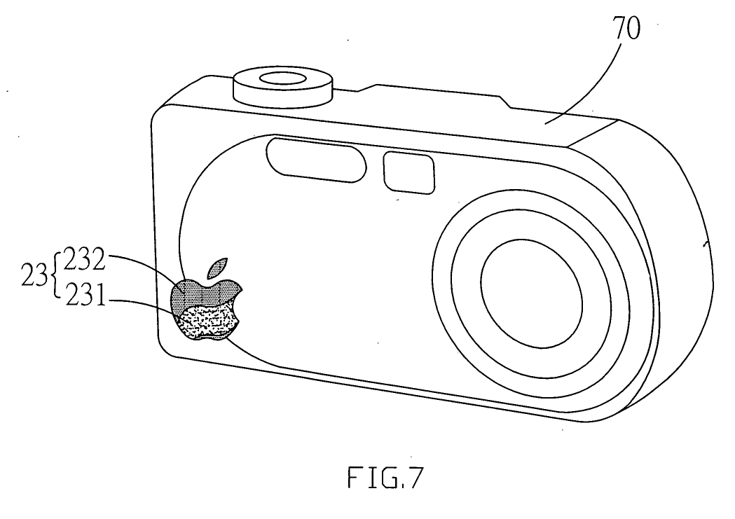

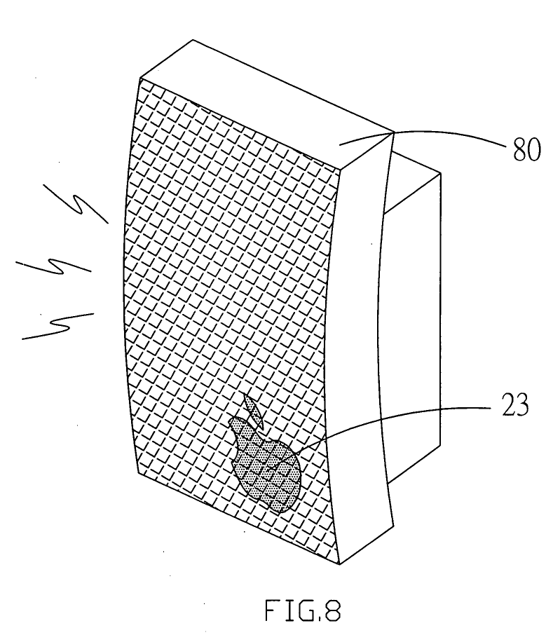

Referring to FIG. 5 for a perspective view of a luminescent decorating panel assembly applied in a notebook computer 50 in accordance with the present invention, the luminescent decorating panel assembly is installed at the bottom of a keyboard of the notebook computer 50, and the present invention is used for a trademark or a brand to improve the add-on value of the notebook computer 50. Referring to FIGS. 6 and 7 for perspective views of a luminescent decorating panel assembly applied in a personal digital assistant (PDA) 60 in accordance with the present invention, the present invention similarly can improve the add-on value of the product such as a personal digital assistant (PDA) 60 and a digital camera 70. In addition, the invention can be applied to an electric appliance or a speaker. Referring to FIG. 8 for a luminescent decorating panel assembly applied in a speaker in accordance with the present invention, the luminescent decorating panel assembly is installed in a chamber of the speaker 80 which is behind a speaker net layer 81 of the speaker 80, so that users can view the designed visual pattern through the speaker net layer 81.

In summation of the description above, the luminescent decorating panel assembly of the present invention primarily adopts the design of a light guide plate, a light source and an electronic device to show the characteristics of a personalized design on an electronic device to improve the add-on value of the electronic device. Obviously, the present invention enhances the performance over the conventional structure, and further complies with the patent application requirements and thus is duly filed for patent application.

While the invention has been described by means of specific embodiments, numerous modifications and variations could be made thereto by those skilled in the art without departing from the scope and spirit of the invention set forth in the claims.

What is claimed is:

1. A luminescent decorating panel assembly, comprising:
a light guide plate, having an incident plane and a light exit plane, and the light exit plane having a microstructure thereon; and
a light source, disposed on the incident plane of the light guide plate.

2. The luminescent decorating panel assembly of claim 1, further comprising a reflecting element disposed at the bottom of the light guide plate.

3. The luminescent decorating panel assembly of claim 1, wherein the microstructure comprises a first pattern area and a second pattern area, and the first pattern area and the second pattern area include a plurality of microstructures with different distributed patterns, densities, shapes or sizes to constitute different light refraction rates or layers.

4. The luminescent decorating panel assembly of claim 1, wherein the incident plane is disposed on a side of the light guide plate, and the light source is installed on a side of the light guide plate and facing the incident plane.

5. The luminescent decorating panel assembly of claim 1, wherein the incident plane is disposed at a bottom surface of the light guide plate, and the light source is disposed at the bottom of the light guide plate and corresponding to the incident plane.

6. An electronic device with a luminescent decorating panel assembly, comprising:
a lower casing;
an upper casing, installed on the lower casing, and having a transparent portion;
a light guide plate, including an incident plane and a light exit plane, and the light exit plane having a microstructure; and
a light source, installed on an incident plane corresponding to the light guide plate;
wherein the light guide plate and the light source are disposed between the upper casing and the lower casing, and the microstructure corresponds to the transparent portion.

7. The electronic device with a luminescent decorating panel assembly of claim 6, wherein the incident plane is disposed on a side of the light guide plate, and the light source is disposed on internal sides of the upper casing and the lower casing and facing the incident plane.

8. The electronic device with a luminescent decorating panel assembly of claim 7, further comprising a reflecting element disposed at the bottom of the light guide plate.

9. The electronic device with a luminescent decorating panel assembly of claim 6, wherein the incident plane is disposed at the bottom surface of the light guide plate, and the light source is disposed at the top of the bottom surface of the lower casing and facing the incident plane.

10. The electronic device with a luminescent decorating panel assembly of claim 9, further comprising a reflecting element disposed at the bottom of the light guide plate.

11. The electronic device with a luminescent decorating panel assembly of claim 10, wherein the electronic device is one selected from the collection of a notebook computer, a digital camera, a personal digital assistant, a mobile phone, a speaker and an electric appliance.
